(19) United States
(12) Patent Application Publication
(10) Pub. No.: US 2026/0050479 A1
(43) Pub. Date: Feb. 19, 2026

(54) SYSTEM AND METHOD FOR RECOMMENDATION AND OPTIMIZATION OF INFORMATION TECHNOLOGY SERVER RESOURCES

(71) Applicant: HybridAI Pte Ltd., Singapore (SG)

(72) Inventors: Rajesh Chainani, Singapore (SG); Simon Rizkallah, Singapore (SG); Ramesh R, Singapore (SG)

(73) Assignee: HybridAI Pte Ltd., Singapore (SG)

(21) Appl. No.: 19/239,261

(22) Filed: Jun. 16, 2025

Related U.S. Application Data
(63) Continuation-in-part of application No. 18/804,529, filed on Aug. 14, 2024, now Pat. No. 12,360,818.

(51) Int. Cl. G06F 9/50; G06F 11/34

(52) U.S. Cl. CPC G06F 9/5027; G06F 11/3433; G06F 2201/805; G06F 2209/501

(57) ABSTRACT

A system for recommendation and optimization of information technology (IT) server resources is disclosed. The system includes a server comprising at least one processor configured to access input datasets associated with an IT workload, determine types and counts of server resources based on predefined criteria and a server consolidation configuration, and access a multi-server performance database. The processor utilizes a trained deep learning model to predict infrastructure requirements and generate recommendations for an optimal server configuration by balancing performance, power consumption, and resource utilization. The processor automatically allocates server resources from multiple manufacturers based on the recommendations and generates data for display on a user interface dashboard. The dashboard presents server utilization patterns, recommended configurations, and real-time performance metrics of allocated resources. The system enables intelligent consolidation and efficient server management within a datacenter environment.

### FIELD OF TECHNOLOGY

The present disclosure relates to the field of cloud computing and IT infrastructure management. Moreover, the present disclosure relates to a system and a method for recommendation and optimization of information technology (IT) server resources.

### BACKGROUND

Enterprises have increasingly adopted large-scale datacenters to support virtualized environments for delivering business-useful information technology (IT) workloads. Such IT workloads, which include enterprise applications, internal services, and user-facing software, rely on a server infrastructure that includes general-purpose computing units and associated virtualization platforms. As the volume and complexity of IT workloads continue to grow, optimizing server infrastructure to ensure efficiency, cost-effectiveness, and energy sustainability has become a significant challenge for IT operations.

Conventional approaches to IT workload management and server resource allocation often utilize independent tools for monitoring, migration, and performance tracking. However, such independent tools may lack a unified framework for providing end-to-end visibility, predictability, and actionable recommendations across diverse server architectures, virtualization layers, and datacenter conditions. In addition, the existing solutions tend to focus narrowly on metrics such as CPU utilization or memory allocation without offering a comprehensive view of server efficiency that includes multi-objective considerations such as power consumption, consolidation potential, and future infrastructure requirements. As a result, datacenters may experience inefficiencies due to under utilized servers, unnecessary energy expenditure, and overprovisioning of hardware resources.

Therefore, in light of the foregoing discussion, there exists a need to overcome the aforementioned drawbacks.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

A system and a method for recommendation and optimization of information technology (IT) server resources in a datacenter environment, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for recommending and optimizing artificial intelligence (AI) workload placement in a multi-vendor cloud environment, in accordance with an embodiment of the present disclosure;

FIG. 2 is a diagram of a customer device displaying a user interface dashboard, in accordance with an embodiment of the present disclosure;

FIG. 3 is a flowchart of a method for recommending and optimizing artificial intelligence (AI) workload placement in a multi-vendor cloud environment, in accordance with an embodiment of the present disclosure;

FIG. 4 is a block diagram of a system for recommendation and optimization of information technology (IT) server resources, in accordance with an embodiment of the present disclosure; and

FIGS. 5A and 5B are a flowchart of a method for recommendation, optimization, validation and actual implementation (execution) of information technology (IT) server resources in a datacenter environment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

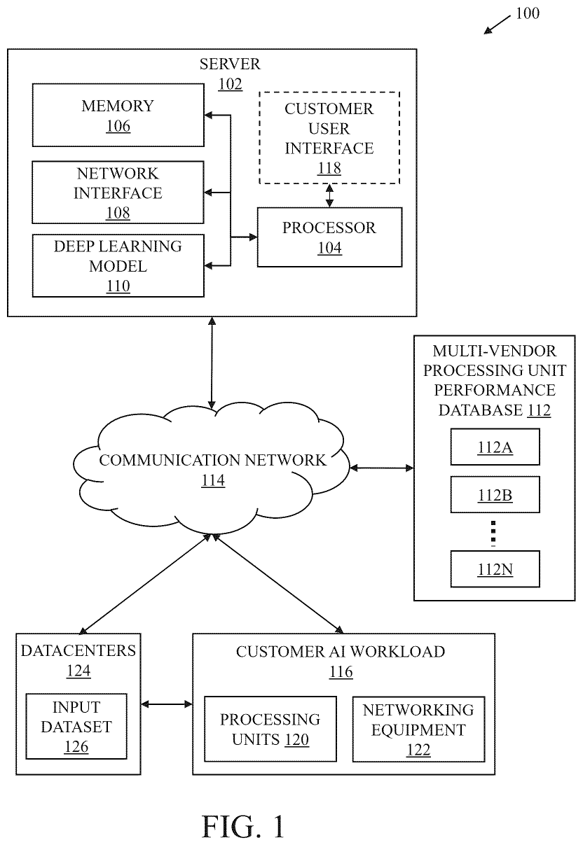

FIG. 1 is a block diagram of a system for recommending and optimizing artificial intelligence (AI) workload placement in a multi-vendor cloud environment, in accordance with an embodiment of the present disclosure. With reference to FIG. 1, there is shown a block diagram of a system 100. The system 100 includes a server 102. The server 102 includes a processor 104 and a memory 106 communicably coupled to the processor 104. In some implementations, the system 100 may include a plurality of processors (similar to the processor 104) to process various operations dedicatedly. The server 102 further includes a network interface 108, a deep learning model 110, and a customer user interface (UI) 118 communicatively coupled to the processor 104. In some implementations, the server 102 is on-premises in the datacenter 124, as shown in FIG. 1. However, in some other implementations, the input dataset 126 may be stored in a cloud environment.

The system 100 further includes a multi-vendor processing unit performance database 112 communicably coupled to the server 102 via a communication network 114. The multi-vendor processing unit performance database 112 includes performance data for one or more types of processing units provided by one or more manufacturers. Specifically, the multi-vendor processing unit performance database 112 includes a first performance dataset 112A for each type of processing unit provided by a first manufacturer, a second performance dataset 112B for each type of processing unit provided by a second manufacturer and so on, up to a Nth performance data 112N for each type processing units provided by a Nth manufacturer. In some other implementations, the multi-vendor processing unit performance database 112 may also be stored on the same server, such as the server 102. Each performance dataset of the multi-vendor processing unit performance database 112 may be retrieved automatically by the processor 104 via the communication network 114 and stored in the memory 106. The server 102 may be communicably coupled to a plurality of customer AI workloads, such as a customer AI workload 116, via the communication network 114. The customer AI workload 116 includes one or more processing units 120 and one or more networking equipment 122. Moreover, the server 102 may be communicably coupled to a plurality of datacenters, such as a datacenter 124. The datacenter 124 is further communicatively coupled to the customer AI workload 116. The datacenter 124 includes an input dataset 126, which may include training data, model parameters, and other relevant datasets associated with the customer AI workload 116. In some implementations, the input dataset 126 is stored on-premises in the datacenter 124, as shown in FIG. 1. However, in some other implementations, the input dataset 126 may be stored in a cloud environment. In some examples, the input dataset 126 may be stored in a network-attached storage (NAS), storage area networks (SAN), or cloud storage services.

The present disclosure provides the system 100 for recommending and optimizing artificial intelligence (AI) workload placement in a multi-vendor cloud environment, where the system 100 access the input datasets 126 stored in the datacenter 124 associated with AI workloads, determines suitable processing units from various manufacturers based on predefined criteria, and calculates the required number of processing units. The system 100 accesses the multi-vendor processing unit performance database 112 and utilizes the deep learning model 110 to predict infrastructure requirements for AI workloads. Based on these predictions and database information, the system 100 generates recommendations for optimal processing unit configurations. The system 100 then automatically allocates processing resources from multiple manufacturers according to the generated recommendations. Finally, the system 100 generates a user interface (UI) dashboard displaying information about various manufacturers, processing unit types, recommended configurations, and real-time performance metrics of allocated resources.

By adopting a multi-vendor approach, the system 100 enables more flexible and efficient utilization of diverse processing units, avoiding vendor lock-in and optimizing cost-performance ratios across different manufacturers. Predictive capabilities of the deep learning model 110 enable proactive infrastructure planning, significantly reducing resource wastage and improving overall system performance. Automatic allocation of processing unit resources based on optimized recommendations streamlines operations, minimizing manual intervention and potential human errors. The real-time performance metrics displayed on the UI dashboard offer enhanced visibility and control, enabling quick adjustments to changing workload demands. The multi-vendor approach yields improved resource utilization, reduced operational costs, and enhanced AI workload performance across various cloud environments.

Furthermore, the adaptability of the system 100 to different types of AI workloads (such as training, inference, and generative AI) makes it a versatile solution for diverse AI applications in cloud computing scenarios. The term “AI workload” refers to computational tasks and processes associated with training, validating, or deploying artificial intelligence models. The AI workloads may vary significantly based on the type of AI task, such as deep learning, machine learning, or natural language processing.

The server 102 includes suitable logic, circuitry, interfaces, and code that may be configured to communicate with the multi-vendor processing unit performance database 112 and the customer AI workload 116 via the communication network 114. In an implementation, the server 102 may be a master server or a master machine that may a part of a datacenter that controls an array of other cloud servers communicatively coupled to it for load balancing, running customized applications, and efficient data management. Examples of the server 102 may include, but are not limited to, a cloud server, an application server, a data server, or an electronic data processing device. In some examples, the server 102 may be deployed on-premises, depending on the customer's infrastructure setup. In some other examples, the server 102 may be deployed in the cloud environment, depending on the customer's infrastructure setup.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures to respond to and may process the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 may refer to a volatile or persistent medium, such as an electrical circuit, magnetic disk, virtual memory, or optical disk, in which a computer can store data or software for any duration. Optionally, the memory 106 may be a non-volatile mass storage device, such as physical storage media. The memory 106 may be configured to store the performance datasets 112A to 112N of the multi-vendor processing unit performance database 112. The memory 106 is further configured to store the input dataset 126 fetched from the datacenter 124. Furthermore, a single memory may encompass multiple memories, and in a scenario where the system 100 is distributed, the processor 104, memory 106, and/or storage capability may be distributed as well. Examples of implementation of the memory 106 may include but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 108 may refer to a hardware and software components that facilitate communication between a computer or device and a network. The network interface 108 acts as a point of connection for sending and receiving data over the communication network 114. The network interface 108 may include network interface cards (NICs), which are physical hardware installed in a computer, or virtual network interfaces used in virtualized environments. The network interface 108 may manage the physical and logical aspects of network connectivity, handling data transmission, reception, and protocol communication to ensure that devices can communicate effectively within a network.

The deep learning model 110 may refer to a sophisticated neural network that may be configured to analyze and interpret large volumes of data from various sources, including data sheets, historical data, and real-time performance data. In some implementations, the deep learning model 110 is trained to predict AI infrastructure requirements by considering factors such as cost, power consumption, and performance metrics. The deep learning model 110 enhances visibility and observability across telemetry, data platforms, and resource consumption, enabling informed decision-making regarding the optimal placement and allocation of AI workloads in a multi-vendor cloud environment. By leveraging deep learning techniques, the deep learning model 110 may provide accurate and context-aware recommendations, ensuring efficient resource utilization and improved overall system performance.

The multi-vendor processing unit performance database 112 may refer to a comprehensive repository that includes performance data for various types of processing units (such as CPUs, GPUs, TPUs, etc.) from multiple manufacturers. The multi-vendor processing unit performance database 112 may contain detailed performance datasets for each type of processing unit provided by different manufacturers, such as the first performance dataset 112A for units from the first manufacturer (e.g., NVIDIA), the second performance dataset 112B for units from the second manufacturer (e.g., AMD), and so on up to the Nth performance dataset 112N for units from the Nth manufacturer (e.g., Intel). The multi-vendor processing unit performance database 112 may include relevant data such as computational power, energy consumption, cost metrics, throughput, and latency, along with other performance indicators. The multi-vendor processing unit performance database 112 aggregates standardized information from vendor data sheets, historical performance metrics from previous AI workloads, and real-time performance data collected from the customer infrastructure. The multi-vendor processing unit performance database 112 serves as a critical resource, enabling the system to access and analyze diverse performance data to make informed decisions about the optimal allocation and placement of AI workloads across the multi-vendor cloud environment.

The communication network 114 may include a medium (e.g., a communication channel) through which the server 102 communicates with the multi-vendor processing unit performance database 112, the customer AI workload 116, and the datacenter 124. The communication network 114 may be a wired or wireless communication network. Examples of the communication network 114 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The customer AI workload 116 may refer to a specific AI workload or application that the customer or end-user is trying to deploy and run in the multi-vendor cloud environment. The customer AI workload is computational tasks required to train, test, or run an AI model. Such tasks may be resource-intensive, involving heavy calculations and data processing.

The customer user interface 118 may refer to a graphic user interface or dashboard on which the customer interacts with the system 100. The customer user interface 118 presents information about the AI workload placement, including details about the processing units from various manufacturers, the recommended optimal configurations, real-time performance metrics, and other relevant data. The customer user interface 118 allows the customer to interact with the system 100, make adjustments, and access reports generated by the system 100.

The processing unit 120 may refer to the hardware components responsible for executing the computational tasks. In the customer AI workload 116, the processing units 120 may include, but are not limited to, CPUs, GPUs, TPUs, DPUs, and the like.

The networking equipment 122 may include but are not limited to, switches and routers to manage data traffic between the processing units 120 and the datacenter 124, network interface cards (NICs) that enable communication between the processing units 120 and other components, and firewalls and load balancers to ensure secure and efficient distribution of data across the infrastructure.

The datacenter 124 may refer to facilities used to house computer systems and associated components, such as telecommunications and storage systems. The datacenter 124 may be configured for the operation of many modern digital services and applications. The datacenters 124 may provide a controlled environment for servers and other critical IT equipment to ensure reliability, security, and efficiency in handling large amounts of data and running applications. The datacenter 124 is configured to store the input dataset 126 associated with the processing unit 120 of the customer AI workload 116.

The input dataset 126 associated with the customer AI workload 116 may include, but are not limited to, three main sources of information. Firstly, data sheets are reference documents provided by vendors of the processing units 120, such as NVIDIA, AMD, and Intel, containing detailed specifications and performance metrics for the processing units 120 (CPUs, GPUs, TPUs, etc.). The data sheets offer standardized information about the capabilities and characteristics of various hardware options available in the multi-vendor cloud environment. In some examples, the datasheets may be in various formats. Such formats may include but are not limited to, PDF, CSV, HTML, or API. Further, the datasheets may include but are not limited to, benchmarks such as throughput, batch size, throughput per Watt, batch size per Watt, throughput per Dollar, batch size per Dollar, latency, different levels of floating-point precision (for example FP64, FP32, FP16), LLM models with various parameters, power consumption, and cost. Secondly, historical data includes past performance data and usage patterns from the customer's previous AI workloads. For brownfield deployments, the historical data provides valuable insights into how different types of AI workloads have performed on various hardware configurations over time. Lastly, real-time data is continuously collected from the customer infrastructure once the system 100 is deployed. The real-time data may include current utilization rates, performance metrics, and other relevant telemetry data from servers, GPUs, CPUs, network cards, virtualization layers, storage systems, and networks. In some examples, the input dataset 126 may include, but not limited to, data and performance reports from various vendors, industry standard performance reports, and brownfield data related to performance from existing infrastructure. By leveraging a combination of data sources, including data sheets, historical data, and real-time data, the system 100 may make informed decisions based on both theoretical capabilities and past performance, as well as current operating conditions, thereby providing more accurate and context-aware recommendations for optimizing AI workload placement across the multi-vendor cloud environment.

In operation, the processor 104 may be configured to access the input dataset 126 stored in the datacenter 124 associated with an AI workload. In some implementations, the system 100 may automatically retrieve relevant data stored in the datacenter 124, which may be in various formats. Some examples of such formats may include but are not limited to, CSV, PDF, or API outputs. The input dataset 126 includes, but not limited to, performance metrics, historical usage patterns, and real-time telemetry from various hardware components like GPUs, CPUs, and storage systems. By accessing the pre-existing data, the processor can efficiently analyze and process the information needed to recommend optimal AI workload placements. The automated data retrieval process not only reduces the need for user intervention but also ensures that the system operates on comprehensive and up-to-date information, leading to more accurate and effective recommendations. In some examples, the processor 104 may interface with storage systems of the datacenter 124 through secure APIs or direct database connections to fetch and process suitable datasets. By accessing the input dataset 126 stored in the datacenter 124, the processor 104 may enable precise recommendations and optimizations based on extensive and up-to-date data, leading to improved performance and cost efficiency in managing AI workloads.

The processor 104 may be further configured to determine one or more types of processing units associated with one or more manufacturers for the input dataset 126 based on a set of predefined criteria. In some implementations, the set of predefined criteria includes at least one of the following: cost, price-performance ratio, or power consumption. In some other implementations, the set of predefined criteria may include, but not limited to, processing speed, cost efficiency, utilization efficiency, energy consumption, throughput, latency, scalability, model accuracy, system reliability and downtime, software compatibility, and optimization. The process involves executing an analysis to compare the specifications and capabilities of various processing units, such as GPUs, CPUs, or TPUs, with the requirements outlined in the input datasets 126. The analysis is conducted through operations that assess how well each type of processing unit meets the workload demands. The processor 104 may identify the processing units that best align with the set of predefined criteria and optimize hardware selection. The processor 104 provides precise matching of processing units to workload requirements, resulting in enhanced performance and efficient resource utilization tailored to the specific needs of the AI application.

In some implementations, the one or more types of processing units may include at least one of the following: graphics processing units (GPUs), tensor processing units (TPUs), central processing units (CPUs), or intelligence processing units (IPUs). However, in some other implementations, the one or more types of processing units may include any other type of processing unit, as required by the application.

The processor 104 may be further configured to determine a count of processing units required for processing the input dataset 126 based on the determined one or more types of processing units. The processor 104 determines the count of the processing units by evaluating the computational needs of the AI workload specified in the input datasets and calculating the number of processing units needed to handle these requirements effectively. The processor 104 is configured to perform such calculations by analyzing the performance metrics of the selected processing units and matching them against the workload demands. The precise determination of the optimal number of processing units required ensures that the workload is processed efficiently and without underutilization or overprovisioning of resources.

The processor 104 may be further configured to access the multi-vendor processing unit performance database 112, which stores the performance data 112A to 112N for the determined one or more types of processing units from one or more manufacturers. The processor 104 may be further configured to access the multi-vendor processing unit performance database 112 by retrieving data on metrics such as throughput, latency, power consumption, and cost associated with each type of processing unit listed in the multi-vendor processing unit performance database 112. The processor 104 is configured to utilize the performance data 112A to 112N to assess and compare the performance characteristics of different hardware options. The ability of the processor 104 to make informed decisions regarding hardware selection by leveraging comprehensive performance data tends to optimal configuration and resource utilization based on empirical evidence.

In some implementations, at least one processor 104 is further configured to update the multi-vendor processing unit performance database 112 with performance data from the allocated processing unit resources. As discussed above, the processor 104 is configured to retrieve data on a certain metrics (such as throughput, latency, power consumption, and cost) associated with each type of processing unit. In some examples based on the metrics mentioned above, the performance data may be outdated, incorrect, or incomplete due to a variety of reasons, including past errors or defects. Thus, the processor 104 automatically analyzes the performance data of the allocated processing unit resources. Then, the processor 104 is configured to find any discrepancies in the performance data stored in the multi-vendor processing unit performance database 112 by comparing the analyzed performance data of the allocated processing unit resources with the performance data stored in the multi-vendor processing unit performance database 112. Lastly, the processor 104 updates the multi-vendor processing unit performance database 112 with updated performance data from the allocated processing unit resources if the performance data falls outside a predefined threshold range.

The processor 104 is further configured to utilize the deep learning model 110 to predict infrastructure requirements for the AI workload. In some implementations, to utilize the deep learning model 110 to predict the infrastructure requirements, at least one processor 104 is further configured to improve visibility into current telemetry data, data platform metrics, and resource consumption. The improved visibility into current telemetry data, data platform metrics, and resource consumption allows the deep learning model 110 to make more informed predictions based on real-time and historical data. The system 100 collects and analyses a wide range of parameters to gain comprehensive insights into the infrastructure's performance and utilization.

For the server platform, the system 100 monitors network interface card (NIC) settings (RDMA/SR-IOV) and status, as well as AI/GPU-specific parameters. In an open-source container orchestration environment, the system 100 tracks node usage (including CPU, memory, GPU, storage, power, network, and NIC type), node status, pod usage, storage utilization, and various components like pods, services, deployments, controllers, and daemonsets. The system 100 also integrates with the open-source container orchestration environment for logs and alerts, monitors node-to-pod locations, and analyses resource utilization patterns.

In the case of a centralized management utility for virtual machines (VMs), the system 100 observes the ESXi status and usage, VM utilization, storage utilization, hardware health as reported by the sensors of the centralized management utility, and latency. The diverse data points provide a holistic view of the performance across different layers and technologies of the infrastructure.

By incorporating the detailed metrics into its analysis, the deep learning model 110 may make highly accurate predictions about the infrastructure requirements for specific AI workloads. The predictive capability enables the system to generate optimal processing unit configurations, taking into account factors such as performance, cost-effectiveness, and power efficiency across multiple vendors.

In some implementations, the deep learning model 110 is configured to dynamically adjust its predictions based on real-time performance metrics of the allocated processing unit resources. In such implementations, the improved visibility also allows for dynamic adjustments to resource allocation based on real-time performance data. The adaptability ensures that AI workloads receive the necessary resources while maintaining overall system efficiency. Furthermore, the comprehensive data collection supports advanced features like load balancing, cost optimization through dynamic reallocation, and the generation of detailed performance reports and alerts.

The deep learning-driven approach to infrastructure prediction and optimization enables organizations to maximize the utilization of their multi-vendor cloud resources, reduce costs, and ensure optimal performance for their AI workloads in complex, heterogeneous computing environments.

In some implementations, the deep learning model 110 is trained on historical resource usage, performance, and cost data. In such implementations, training the deep learning model 110 on the historical resource usage patterns encompasses CPU, memory, GPU, and storage utilization across various AI workloads over time. By analyzing these patterns, the deep learning model 110 learns to identify trends and correlations between workload characteristics and resource demands. Further, by training the deep learning model 110 on performance metrics, the deep learning model 110 incorporates data on execution times, throughput, and latency for different types of AI tasks on various processing units. The performance metrics help the model understand the performance capabilities of different hardware configurations. By training the deep learning model 110 on the cost data, historical pricing information for different processing units and cloud services is included to enable cost-effective recommendations. The cost data and historical pricing information for different processing units and cloud services help the deep learning model 110 to balance performance requirements with budgetary constraints.

In some other implementations, the deep learning model 110 may be trained on a comprehensive dataset that includes, but not limited to, workload characteristics, multi-vendor hardware specifications, energy consumption data, scaling behaviour, failure and maintenance records, network utilization and data transfer patterns, and seasonal and temporal variations.

In some examples, the deep learning model 110 is trained on data describing the nature of different AI workloads, such as model architecture, dataset size, and computational complexity. The training of the deep learning model 110 helps in predicting resource requirements for specific types of AI tasks. In another example, detailed information about the capabilities and limitations of processing units from various manufacturers is incorporated into the training data. The detailed information enables the deep learning model 110 to make informed decisions when recommending optimal configurations across different vendors. In yet another example, historical data on power usage for different hardware configurations may be included to optimize energy efficiency, an increasingly important factor in data center operations. In yet another example, the deep learning model 110 learns how resource requirements change as workloads scale up or down, enabling accurate predictions for various sizes of AI projects. In some other examples, By incorporating data on hardware failures and maintenance schedules, the deep learning model 110 may factor in reliability and availability when making recommendations. In other examples, network utilization and data transfer patterns helps the deep learning model 110 optimize for scenarios where data movement between nodes or clusters is a significant factor. In some other examples, the deep learning model 110 learns to account for time-based patterns in resource demand, such as peak usage periods or cyclical workloads.

In some implementations, by training on a diverse and comprehensive dataset, the deep learning model 110 develops the capability to make nuanced, context-aware predictions. The deep learning model 110 may identify complex relationships between various factors affecting infrastructure requirements, enabling the deep learning model 110 to generate highly optimized recommendations for AI workload placement and resource allocation.

In some implementations, the training process of the deep learning model 110 involves techniques such as supervised learning on labelled historical data, as well as \incorporating reinforcement learning elements to optimize decision-making over time. Regular retraining with new data ensures that the deep learning model 110 stays up-to-date with the latest hardware developments and evolving workload patterns.

The data-driven approach allows the system 100 to continually improve its predictive accuracy and adapt to changing conditions in the multi-vendor cloud environment. As a result, organizations can achieve more efficient resource utilization, reduced costs, and improved performance for their AI workloads across diverse and complex computing infrastructures.

The processor 104 may be further configured to generate recommendations for an optimal processing unit configuration based on the multi-vendor processing unit performance database 112 and the predicted infrastructure requirements. The processor 104 generates the recommendations for the optimal processing unit configuration and ensures that AI workloads are allocated the most suitable resources across different manufacturers, optimizing performance and cost-efficiency. The processor 104 analyses the performance characteristics of various processing units in conjunction with the specific needs of the AI workload to determine the ideal configuration.

The processor 104 may be further configured to automatically allocate processing unit resources from the one or more manufacturers based on the recommended optimal processing unit configuration. The automatic allocation of processing unit resources streamlines the resource provisioning process, reducing manual intervention and potential human errors. The automatic allocation of the processing unit resources allows for rapid deployment of AI workloads across a heterogeneous computing environment, maximizing the utilization of available resources from different vendors. In some implementations, the at least one processor 104 may be further configured to perform load balancing across the allocated processing unit resources from the one or more manufacturers. The processor 104 performs load balancing across the allocated processing unit resources to ensure that workloads are distributed evenly, preventing bottlenecks and optimizing overall system performance. The load balancing mechanism adapts to real-time conditions, redistributing tasks as necessary to maintain optimal utilization of all available resources. The system 100 uses real-time performance metrics collected from the allocated processing units. The real-time performance metrics, combined with the performance data stored in the multi-vendor processing unit performance database 112, allow the system 100 to make informed decisions about how to distribute the workload. The load balancing operation may consider factors such as processing speed, memory capacity, energy efficiency, and current utilization of each unit when the processor 104 decides how to allocate tasks.

Performing the load balancing across the allocated processing unit resources complements the other capabilities of the system 100, such as dynamically adjusting resource allocation based on real-time performance and pricing information. The processor 104 creates a highly adaptable and efficient system for managing AI workloads across diverse hardware resources in a multi-vendor cloud environment.

In some implementations, the at least one processor 104 may be further configured to optimize resources cost by dynamically reallocating processing unit resources based on real-time pricing information from the one or more manufacturers. Cost optimization is achieved through dynamic reallocation of the processing unit resources based on real-time pricing information from multiple manufacturers. The dynamic reallocation allows the system 100 to take advantage of fluctuations in resource costs, shifting workloads to more cost-effective options as the processing unit resources become available. The dynamic allocation of processing unit resources helps organizations minimize expenses while maintaining performance standards.

The processor 104 may be further configured to generate data for display on the user interface dashboard presenting information about the one or more manufacturers, the determined one or more types of processing units, the recommended optimal processing unit configuration, and real-time performance metrics of allocated processing unit resources. The UI dashboard presents a wide range of information, starting with details about the various hardware manufacturers involved in the customer AI infrastructure. The UI dashboard may include, but not limited to, names of leading GPU manufacturers, major CPU providers, and prominent cloud service companies. The UI dashboard also displays information about the types of processing units in use, which may encompass GPUs, TPUs, CPUs, or IPUs, along with their specific models and capabilities.

Furthermore, the UI dashboard displays the recommended optimal processing unit configuration. The recommended optimal processing unit configuration may be presented as a graphical representation of the suggested hardware layout, including the number and type of each processing unit, their interconnections, and how each processing unit is distributed across different manufacturers or cloud providers. The recommended optimal processing unit configuration helps customers to understand the rationale behind the recommendations of the system 100 and allows them to make informed decisions about the infrastructure.

Real-time performance metrics of the allocated processing unit resources are another crucial component of the UI dashboard. The real-time performance metrics may include, but not limited to GPU utilization rates, memory usage, processing speeds, power consumption, and job completion times. The UI dashboard may present the real-time performance metrics through dynamic charts, graphs, or heat maps, allowing the customers to quickly identify performance bottlenecks or underutilized resources.

Additional examples of information that may be presented on the UI dashboard include, but are not limited to, cost analytics, showing current spending and projections based on resource usage, comparative performance data, illustrating how different processing units or configurations perform for specific AI workloads, energy efficiency metrics, helping the customers understand the environmental impact of their AI operations, workload distribution visualizations, showing how tasks are balanced across different resources, historical performance trends, allowing the customers to track improvements or degradations over time, alerts and notifications for any performance issues or resource constraints, and predictive analytics, suggesting future resource needs based on current usage patterns.

By providing complex information valuable to the customers in a simple format, the UI dashboard empowers customer to make data-driven decisions about the AI infrastructure. The UI dashboard allows for quick identification of issues, validation of the recommendations of the system 100, and provides the transparency needed for the customers to trust and effectively manage their complex, multi-vendor AI environments. The level of visibility and control by quick identification of issues, validation of the recommendations of the system 100 is essential for optimizing both the performance and cost-effectiveness of AI workloads in diverse cloud ecosystems today.

In some implementations, the user interface dashboard may provide options for manual override of the recommended optimal processing unit configuration. In other words, to accommodate specific customer requirements or unforeseen circumstances, the user interface dashboard includes options for manual override of the recommended optimal processing unit configuration. The feature of manual override provides flexibility and allows human operators to intervene when necessary, ensuring that the system 100 can adapt to unique situations or preferences not captured by the automated recommendation process.

In some implementations, the at least one processor 104 may be further configured to decide policy criteria for the AI workload and resource access using an AI policy and resource manager. In other words, the processor 104 may incorporate an AI policy and resource manager to decide policy criteria for AI workloads and resource access. Deciding the policy criteria ensures that resource allocation and workload management adhere to organizational policies, security requirements, and compliance standards. Also, deciding the policy criteria provides a framework for consistent and controlled access to resources across the multi-vendor environment.

In some implementations, the at least one processor 104 may be further configured to generate alerts when the real-time performance metrics deviate from the predicted infrastructure requirements by a predetermined threshold. In other words, to maintain health and performance of the system 100, the processor 104 generates alerts when real-time performance metrics deviate from predicted infrastructure requirements by the predetermined threshold. The proactive monitoring by the processor 104 to generate alerts allows for timely intervention in case of unexpected performance issues or resource shortages, helping to maintain the efficiency and reliability of the AI infrastructure.

In some implementations, the at least one processor 104 may be further configured to generate a report comparing the predicted infrastructure requirements with actual performance metrics of the allocated processing unit resources. Specifically, for analytical purposes, the processor 104 generates reports comparing predicted infrastructure requirements with the actual performance metrics of allocated processing unit resources. The generated reports provide valuable feedback on the accuracy of the deep learning model 110 and the efficiency of resource allocation, enabling continuous improvement of the predictive capabilities and optimization strategies of the system 100.

In some implementations, the at least one processor 104 may be further configured to simulate different processing unit configurations before actual allocation to optimize resource utilization. Simulating the different processing unit configurations may allow organizations to test various scenarios and configurations without committing actual resources, reducing the risk of suboptimal deployments and enabling more informed decision-making in resource allocation.

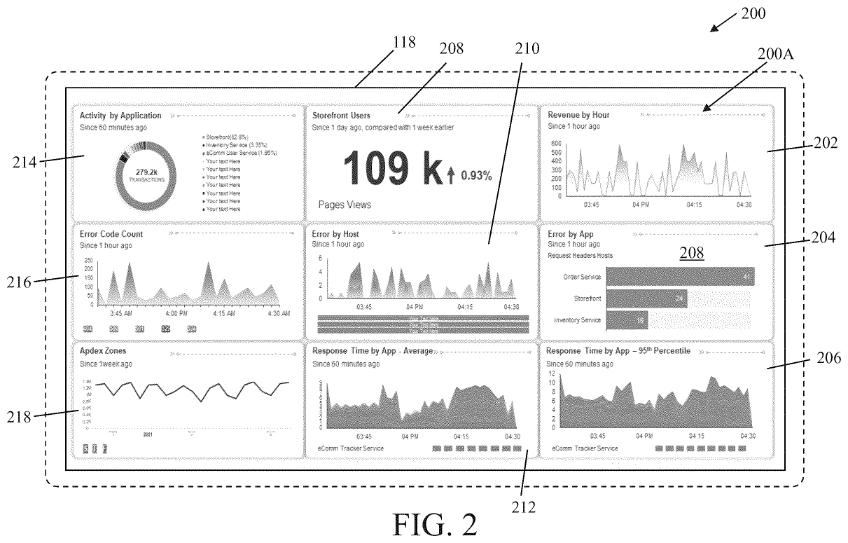

FIG. 2 is a diagram of a customer device displaying a user interface dashboard, in accordance with an embodiment of the present disclosure. FIG. 2 is described in conjunction with elements from FIG. 1. With reference to FIG. 2, there is shown a user interface dashboard 200 displaying the customer user interface 118. The customer UI 118 displays a UI dashboard 200A.

The UI dashboard 200 includes multiple data visualization components that provide real-time performance metrics and analytics for the AI workload optimization system. The data visualization components include a revenue by hour graph 202 displaying hourly revenue trends, an error by app bar chart 204 showing error rates for different applications or services, and a response time by app percentile chart 206 illustrating response time distributions across applications. At the center of the dashboard is a central metric display 208 showing a key performance indicator (109K views in this case) with a percentage change indicator. The UI dashboard 200 also features an error by host graph 210, which depicts error rates across different host machines, and a response time by app average chart 212, showing the average response times for various applications. An activity by application pie chart 214 displays the distribution of activity across different applications, while an error code count graph 216 shows the frequency of various error codes over time. Finally, a line graph 218 illustrates performance zones over time. The x-axis of the line graph 218 likely represents a time scale, allowing the customers to view performance trends over hours, days, or even longer periods. The y-axis appears to show the distribution of performance across different zones, which may be categorized based on predefined thresholds or service level agreements (SLAs).

Each of data visualization components 202 to 218 provides specific insights into different aspects of system performance, allowing the customers to monitor, analyze, and optimize AI workload placement and resource allocation in real-time. The UI dashboard 200 is designed to offer a comprehensive overview of system health, performance, and efficiency metrics in an easily digestible visual format, enabling the customers to make informed decisions about resource allocation and workload optimization.

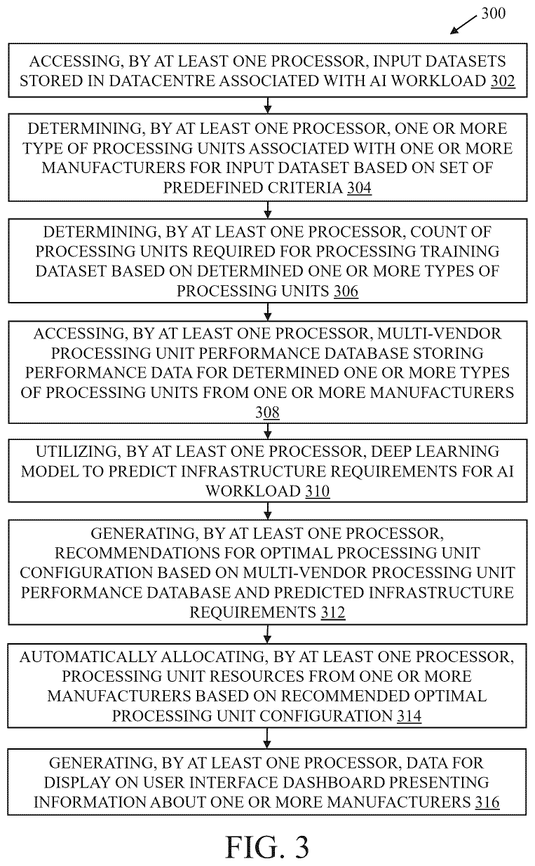

FIG. 3 is a flowchart of a method for recommending and optimizing artificial intelligence (AI) workload placement in a multi-vendor cloud environment, in accordance with an embodiment of the present disclosure. FIG. 3 is explained in conjunction with elements from FIGS. 1 and 2. With reference FIG. 3, there is shown a flowchart of a method 300. The method 300 is executed at the server 102 (of FIG. 1). The method 300 may include steps 302 to 316.

At 302, the system 100 accesses the input datasets 126 stored in the datacenter 124 associated with the AI workload (i.e., the customer AI workload 116). The system 100 has access to the necessary data for processing the AI workload. By centralizing data access, the system 100 allows for efficient data management and reduces data transfer overhead, suitable for large-scale AI operations.

At 304, the system 100 determines, by the at least one processor 104, the one or more type of processing units associated with the one or more manufacturers for the input datasets 124 based on the set of predefined criteria. In some embodiments, the set of predefined criteria may include at least one of cost, price-performance ratio, or power consumption. The processor 104 may be configured to match the AI workload requirements with the most suitable types of processing units. By considering factors such as cost, price-to-performance ratio, and power consumption, the processor 104 optimizes resource allocation and potentially reduces operational costs.

In some implementations, the one or more types of processing units may include at least one of the following: graphics processing units (GPUs), tensor processing units (TPUs), central processing units (CPUs), or intelligence processing units (IPUs).

At 306, the system 100 determines, by the at least one processor 104, a count of processing units required for processing the input datasets 124 based on the determined one or more types of processing units. The system 100 determines the right amount of processing power required to allocate to the AI workload, preventing both under-provisioning (which may lead to performance issues) and over-provisioning (which may result in unnecessary costs).

At 308, the system 100 accesses, by the at least one processor 104, the multi-vendor processing unit performance database 112 which stores the performance data for the determined one or more types of processing units from the one or more manufacturers. The system 100 may be configured to make informed decisions based on real-world performance data across various manufacturers. The processor 104 enables cross-vendor comparisons and helps in selecting the most efficient hardware for specific AI tasks.

At 310, the system 100 utilizes, by the at least one processor 104, the deep learning model 110 to predict infrastructure requirements for the AI workload. In such implementations, utilizing the deep learning model 110 further includes improving, the at least one processor 104, visibility into current telemetry data, data platform metrics, and resource consumption. In some implementations, the deep learning model 110 may be trained on historical resource usage, performance, and cost data. By utilizing the deep learning model 110, trained on historical data, the system 100 may enable the accurate prediction of infrastructure requirements. The processor 104 may be configured to improve resource allocation efficiency and help in proactive capacity planning.

At 312, the system 100 further generates, by the at least one processor 104, the recommendations for the optimal processing unit configuration based on the multi-vendor processing unit performance database 112 and the predicted infrastructure requirements. The system 100 may be configured to synthesize the information from the performance database and the deep learning model 110 to provide optimal configuration recommendations. The synthesized information eliminates the complexity of hardware selection and configuration, potentially leading to improved performance and cost efficiency.

At 314, the system 100 automatically allocates, by the at least one processor 104, the processing unit resources from one or more manufacturers based on the recommended optimal processing unit configuration. Automation of resource allocation reduces human error, speeds up deployment, and ensures that the optimal configuration is implemented accurately.

At 316, the system 100 further generates, by the at least one processor 104, data for display on the user interface dashboard 200 presenting information about the one or more manufacturers, the determined one or more types of processing units, the recommended optimal processing unit configuration, and real-time performance metrics of the allocated processing unit resources.

In some implementations, the system 100 may further decide, by the at least one processor 104, the policy criteria for the AI workload and resource access using an AI policy and resource manager. The system 100 may ensure that resource allocation and AI workload management adhere to predefined policies. The processor 104 helps maintain security, compliance, and operational standards across various AI workloads and resources.

The steps 302 to 316 are only illustrative, and other alternatives can also be provided where one or more steps are added, one or more steps are removed, or one or more steps are provided in a different sequence without departing from the scope of the claims herein.

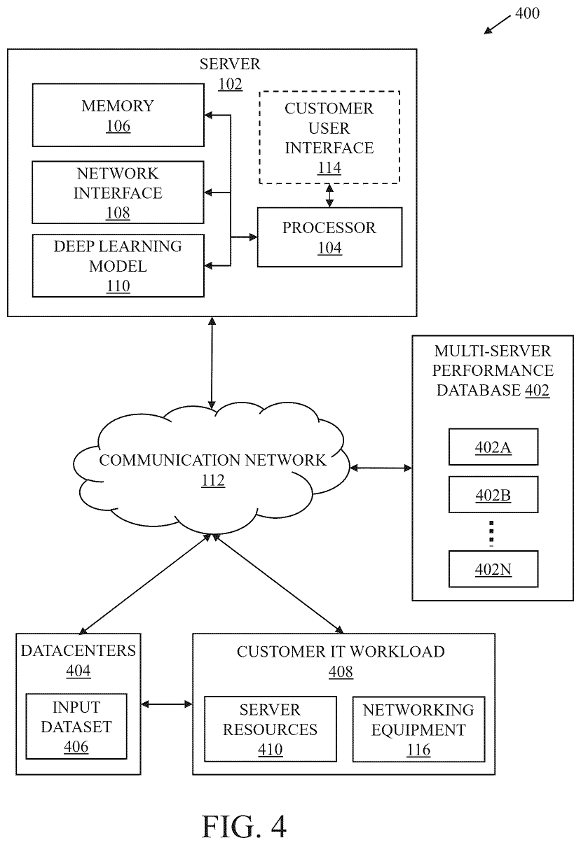

FIG. 4 is a block diagram of a system for recommendation and optimization of information technology (IT) server resources, in accordance with an embodiment of the present disclosure. FIG. 4 is explained in conjunction with elements from FIGS. 1 to 3. With reference to FIG. 4, there is shown a block diagram of a system 400. The system 400 is substantially similar to system 100 of FIG. 1 in terms of functionality and hardware components. However, the system 400 may be configured for recommendation and optimization of information technology (IT) server resources. The system 400 may include the server 102. The server 102 includes the processor 104, and the memory 106 communicably coupled to the processor 104. In some implementations, the system 400 may include a plurality of processors (similar to the processor 104) to process various operations dedicatedly. The server 102 further includes a network interface 108, the deep learning model 110, and the customer user interface (UI) 118 communicatively coupled to the processor 104. In some implementations, the server 102 is on-premises in a data center 404, as shown in FIG. 4. However, in some other implementations, the input dataset 406 may be stored in a cloud environment.

The system 400 further includes a multi-server performance database 402 communicably coupled to the server 102 via a communication network 114. The multi-server performance database 402 includes performance data for one or more types of server resources provided by one or more manufacturers. Specifically, the multi-server performance database 402 includes a first performance dataset 402A for each type of server resources provided by a first manufacturer, a second performance dataset 402B for each type of server resources provided by a second manufacturer and so on up to a Nth performance data 402N for each type processing units provided by a Nth manufacturer. In some other implementations, the multi-server performance database 402 may also be stored on the same server, such as the server 102. Each performance dataset of the multi-server performance database 402 may be retrieved automatically by the processor 104 via the communication network 114 and stored in the memory 106. The server 102 may be communicably coupled to a plurality of customer IT workloads, such as a customer IT workload 408, via the communication network 114. The customer IT workload 408 includes one or more server resources 410 and one or more networking equipment 122. Moreover, the server 102 may be communicably coupled to a plurality of data centers, such as the datacenter 404. The datacenter 404 is further communicatively coupled to the customer IT workload 408. The datacenter 404 includes an input dataset 406, which may include training data, model parameters, and other relevant datasets associated with the customer IT workload 408. In some implementations, the input dataset 406 is stored on-premises in the data center 404, as shown in FIG. 4. However, in some other implementations, the input dataset 406 may be stored in a cloud environment. In some examples, the input dataset 406 may be stored in a network-attached storage (NAS), storage area networks (SAN), or cloud storage services.

By adopting a comprehensive server consolidation approach, the system 400 enables more efficient utilization of physical server resources, reducing the total number of servers required while maintaining suitable performance levels. The predictive capabilities of the deep learning model 110 enable proactive infrastructure planning based on historical utilization patterns, thereby reducing resource wastage and enhancing overall data centre efficiency. The multi-objective optimization utilizing the Pareto front approach provides balanced solutions that simultaneously optimize performance, power consumption, and resource utilization, thereby avoiding suboptimal single-objective approaches. Automatic allocation of server resources based on optimized recommendations streamlines datacenter operations, minimizing manual intervention and potential configuration errors. The agentless data collection provides comprehensive monitoring of server resources without imposing additional overhead, enabling accurate analysis of utilization patterns. The real-time performance metrics displayed on the UI dashboard offer enhanced visibility and control, enabling quick adjustments to changing workload demands and proactive identification of issues. The comprehensive server consolidation approach offers an improved server consolidation ratio, reduced power consumption, decreased operational costs, and enhanced IT workload performance across various data centre environments. Furthermore, the adaptability of the system 400 to different types of IT workloads, including enterprise applications, database systems, and web services, makes the system 400 a suitable solution for diverse IT infrastructure scenarios.

The multi-server performance database 402 stores comprehensive performance data for various types of server resources deployed across the datacenter 404. The multi-server performance database 402 may include detailed metrics, such as CPU utilization patterns, memory consumption statistics, power consumption data, thermal characteristics, and response times for various server configurations. The first performance dataset 402A may contain performance metrics for server resources from a first manufacturer, including specifications such as processing capabilities, energy efficiency ratings, and operational parameters under various load conditions. Similarly, the second performance dataset, 402B, and subsequent datasets, up to the Nth performance dataset, 402N, may contain corresponding performance data for server resources from different manufacturers, enabling comprehensive cross-vendor performance analysis and optimization.

The datacenter 404 refers to a physical or virtualized computing environment that houses multiple server resources and associated infrastructure components. The datacenter 404 may include cooling systems, power distribution units, network switching equipment, and storage systems that support the operation of server resources. The input dataset 406, stored within the datacenter 404, contains historical and real-time data related to IT workload performance, including server utilization metrics, application performance indicators, resource consumption patterns, and operational logs. The input dataset 406 serves as a foundation for training the deep learning model 110 and generating predictive analytics for optimizing server resources.

The customer IT workload 408 refers to the computing tasks and applications that require processing resources within the datacenter environment. The customer IT workload 408 may include enterprise applications, database operations, web services, batch processing jobs, and other computational tasks that consume server resources. The one or more server resources 410 within the customer IT workload 408 may include physical servers, virtual machines, containers, and associated computing infrastructure that execute the IT workload operations. The server resources 410 may vary in configuration, including different CPU architectures, memory capacities, storage types, and networking capabilities, depending on the specific requirements of the IT workload.

The input dataset 406 associated with the customer IT workload 408 includes, but not limited to, three main sources of information. The first source of information includes server specification documents which are reference materials provided by manufacturers of server resources such as Dell, HPE, IBM, and Cisco, containing detailed technical specifications and performance characteristics for various server configurations including CPUs, memory modules, storage systems, and networking components. The server specification documents provide standardized information about the capabilities, compatibility matrices, and operational parameters of different hardware options available in the datacenter environment. In some examples, the server specifications may be in various formats. Such formats may include, but are not limited to, PDF, CSV, XML, JSON, or API responses. Further, the server specifications may include, but not limited to, performance benchmarks such as CPU processing capacity, memory bandwidth, storage throughput, network performance metrics, power consumption profiles, thermal characteristics, CPU utilization thresholds, memory utilization patterns, storage input-output operations per second, network latency measurements, and cost per performance ratios. The second source of information includes historical utilization data, such as past performance records and usage patterns, from the customer's existing IT infrastructure. For brownfield datacenter deployments, the historical utilization data provides valuable insights into how different types of IT workloads have performed on various server configurations over extended periods, including seasonal variations, peak usage patterns, and resource consumption trends. The third source of information includes real-time telemetry data which is continuously collected from the customer datacenter infrastructure once the system 400 is deployed. The real-time telemetry data includes current server utilization rates, CPU performance metrics, memory consumption statistics, storage input-output patterns, network traffic data, power consumption measurements, and operational data from physical servers, virtual machines, hypervisors, storage arrays, network switches, and management systems. In some examples, the input dataset 406 may include, but not limited to, server performance reports from various manufacturers, industry-standard IT infrastructure benchmarks, virtualization performance data, and brownfield operational data from existing datacenter deployments. By leveraging such a combination of data sources, server specifications, historical utilization data, and real-time telemetry data, the system 400 may make informed decisions based on both theoretical server capabilities, past operational performance, and current datacenter conditions, thus providing more accurate and context-aware recommendations for optimizing IT server resource allocation and consolidation across the datacenter environment.

In operation, the processor 104 is configured to access the input datasets 406 stored in the datacenter 404 associated with an IT workload. In some implementations, the system 400 automatically retrieves relevant data stored in the datacenter 404, which may be in various formats. Some examples of such formats may include, but are not limited to, CSV, XML, JSON, PDF, or API outputs from virtualization management systems and server monitoring tools. The input datasets 406 includes, but not limited to, server performance metrics, historical utilization patterns, virtual machine operational data, and real-time telemetry from various infrastructure components like physical servers, storage arrays, network switches, and virtualization platforms. By accessing the pre-existing data, the processor 104 can analyze and process the information needed to recommend optimal server consolidation strategies and resource allocation plans. The automated data retrieval process reduces the need for manual data collection and user intervention and also ensures that the system 400 operates on comprehensive and up-to-date information, leading to more accurate and effective server optimization recommendations. In some examples, the processor 104 interfaces with datacenter management systems through secure APIs, SNMP protocols, or direct database connections to fetch and process the necessary server performance and utilization datasets. By virtue of accessing the input dataset 406 stored in the datacenter 404, this may enable precise server consolidation recommendations and optimizations based on extensive and current operational data, leading to improved resource utilization efficiency and cost-effectiveness in managing IT server infrastructure.

The processor 104 may be further configured to determine one or more types of server resources for the input datasets based on a set of predefined criteria. In an implementation, the predefined criteria may include CPU utilization thresholds, power consumption limits, or server performance requirements. The predefined criteria define the operational parameters for optimal resource allocation. The processor 104 evaluates various server configurations, including different CPU architectures, memory capacities, and storage types, to identify suitable server resources that meet the specified criteria and can efficiently handle the IT workload requirements.

In an implementation, the processor 104 may be configured to determine server utilization patterns based on historical and real-time performance data collected from a plurality of servers in the datacenter 404 through sophisticated data analysis and pattern recognition algorithms. The processor 104 executes time-series analysis algorithms that process performance data streams to identify recurring patterns, seasonal variations, and trending behaviours in server resource consumption. The server utilization patterns may include CPU usage trends that capture peak and idle periods throughout daily, weekly, and monthly cycles, memory consumption patterns that identify baseline memory requirements and spike occurrences, I/O operations frequency that measures storage and network activity patterns, and power consumption variations over time that correlate with workload intensity and environmental factors.

The processor 104 may be configured to employ statistical analysis techniques, including moving averages, regression analysis, and correlation coefficient calculations, to establish baseline utilization metrics and identify deviations from normal operational patterns. The pattern determination process involves data preprocessing steps that filter out noise and anomalies, followed by feature extraction algorithms that identify key performance indicators representative of server behaviour. The processor 104 applies machine learning clustering algorithms, such as k-means clustering or hierarchical clustering, to group servers with similar utilization characteristics, enabling the identification of server cohorts that exhibit comparable resource consumption patterns.

In another implementation, server utilization patterns are collected using an agentless collector that interfaces with virtualization management systems to gather various performance metrics without requiring additional software installation on the monitored servers. The virtualization management system may refer to a software platform or control layer configured to manage and monitor virtualized infrastructure, including virtual machines (VMs), hypervisors, storage resources, and host servers. Examples of virtualization management systems may include VMware vCenter, Microsoft System Center Virtual Machine Manager (SCVMM), and other similar platforms. The virtualization management system expose application programming interfaces (APIs) that allow external tools, such as the agentless collector, to retrieve telemetry and configuration data related to CPU usage, memory allocation, storage activity, VM-to-host mappings, and power states. The virtualization management system serves as a centralized control point for orchestrating workload placement, performing live migration, and gathering real-time performance insights across the virtualized environment. The agentless collector refers to a software component configured to interface with virtualization management system without requiring the installation of agents on individual servers. The agentless collector retrieves performance and telemetry data such as CPU utilization, memory usage, storage input-output, power consumption, and network statistics directly through standard APIs exposed by hypervisors or infrastructure management tools, such as VMware vCenter or similar platforms. By operating in an agentless manner, the collector reduces operational overhead, minimizes compatibility risks, and enables non-intrusive data acquisition across a wide range of server hardware and virtualization environments. The collected data is used as input for predictive modelling, server utilization analysis, and infrastructure optimization. The agentless collector utilizes standardized management protocols, including Simple Network Management Protocol (SNMP), Windows Management Instrumentation (WMI), and RESTful APIs, to remotely access server performance counters and system telemetry data. The agentless collector establishes secure connections with hypervisor management interfaces such as VMware vCenter Server, Microsoft System Center Virtual Machine Manager, or open-source virtualization platforms to extract comprehensive performance datasets.

The agentless collector implements polling mechanisms that retrieve performance data at configurable intervals, typically ranging from one minute to fifteen minutes, ensuring the capture of both short-term fluctuations and long-term trends in server utilization. The agentless collector may gather up to fifty-three different performance metrics, providing comprehensive visibility into server resource utilization and operational characteristics, including CPU utilization percentages per core, memory usage statistics including committed and available memory, storage input-output operations per second and throughput measurements, network interface utilization and packet statistics, power consumption readings from intelligent platform management interfaces, thermal sensor data, and virtualization-specific metrics such as virtual machine density and resource allocation efficiency.

Memory-related performance metrics include memory usage statistics comprising committed memory allocation, available physical memory, virtual memory utilization, memory page fault rates, memory swap activity indicators, memory bandwidth utilization measurements, and memory allocation efficiency ratios. The agentless collector captures storage performance indicators, including storage input-output operations per second for both read and write operations, storage throughput measurements in megabytes per second, storage queue depth metrics, disk latency measurements including average and peak response times, storage capacity utilization percentages, and storage device health indicators such as error rates and predictive failure metrics.

Network performance metrics collected by the agentless collector encompass network interface utilization percentages for each network adapter, network packet transmission and reception statistics, network error rates including dropped packet counts, network bandwidth consumption measurements, network latency indicators, and network connection state information. Power consumption metrics include total server power draw measurements obtained from intelligent platform management interfaces, individual component power consumption readings for processors and memory modules, power efficiency ratios calculated as performance per watt, thermal characteristics including CPU and ambient temperature readings from multiple sensor locations, cooling system performance indicators, and power supply efficiency measurements.

The processor 104 aggregates the collected performance data into structured datasets organized by server identity, timestamp, and metric type, enabling efficient querying and analysis operations. The pattern determination process incorporates data validation algorithms that verify data integrity, identify missing data points, and apply interpolation techniques to maintain continuity in time-series analysis. The processor 104 calculates derived metrics such as resource utilization ratios, performance efficiency indicators, and workload intensity scores that provide higher-level insights into server operational characteristics and consolidation opportunities.

In an implementation, the processor 104 may be further configured to determine a server consolidation configuration for processing the input datasets based on the determined server utilization patterns. The server consolidation configuration identifies opportunities to redistribute virtual machines and applications across fewer physical servers while maintaining performance requirements and ensuring adequate resource availability. The processor 104 analyses utilization patterns to identify underutilized servers, peak usage periods, and resource allocation inefficiencies that can be addressed through consolidation strategies.

The processor 104 determines a count of servers required for processing the input datasets based on the determined server consolidation configuration. The server count determination involves executing sophisticated mathematical optimization algorithms that calculate the optimal number of physical servers needed to support the consolidated IT workload while achieving predetermined performance levels and maintaining sufficient capacity for peak demand periods. The processor 104 employs bin packing algorithms and constraint satisfaction techniques to evaluate various server allocation scenarios, considering factors such as CPU utilization thresholds, memory requirements, storage capacity constraints, and network bandwidth demands. The optimization process incorporates safety margins and capacity buffers to ensure that the reduced server count can accommodate workload fluctuations and unexpected demand spikes without compromising performance.

In an implementation, the server consolidation configuration reduces the total number of physical servers while maintaining performance requirements by redistributing virtual machines across fewer servers through intelligent placement algorithms. The processor 104 analyzes virtual machine resource profiles, including CPU usage patterns, memory consumption characteristics, and input-output requirements, to identify compatible workloads that can coexist on shared physical servers without resource contention. The consolidation algorithm considers anti-affinity rules for useful applications, ensures adequate resource isolation between different workloads, and maintains compliance with licensing and security policies. The redistribution process optimizes server utilization by maximizing resource density while preserving performance isolation and maintaining fault tolerance through the strategic placement of redundant services across different physical servers.

The server consolidation configuration improves resource utilization efficiency by increasing the average CPU and memory utilization rates across the remaining physical servers, thereby extracting maximum value from existing hardware investments. The consolidation strategy reduces operational overhead by decreasing the number of physical servers that require monitoring, maintenance, cooling, and power consumption, resulting in simplified management complexity and reduced operational costs. The processor 104 calculates projected savings in terms of reduced power consumption, cooling requirements, physical rack space utilization, and maintenance overhead, providing quantifiable benefits from the server consolidation implementation. The optimized server count determination ensures that organizations achieve a higher return on infrastructure investments while maintaining service level agreements and operational reliability standards.

In an implementation, the processor 104 implements an orchestration engine that may be configured to automate the execution of the server consolidation plan through intelligent coordination and management of virtualization infrastructure components across the datacenter 404. The orchestration engine performs automated provisioning and process automation by interfacing with multiple virtualization management platforms simultaneously, including VMware vCenter Server, Microsoft System Center Virtual Machine Manager, and open-source virtualization platforms such as OpenStack or Proxmox. The orchestration process involves the systematic installation and configuration of vendor-specific operators and management agents that enable standardized control interfaces across heterogeneous server environments from different manufacturers represented in the multi-server performance database 402.

In an implementation, the orchestration engine may employ operator stitching algorithms that integrate and coordinate multiple vendor-specific management operators to create a unified control plane for server resource management across diverse hardware platforms. The operator stitching process involves the automated installation of vendor-specific operators such as Dell OpenManage Enterprise operators, HPE OneView management operators, and Cisco Intersight operators, followed by the creation of abstraction layers that enable coordinated management through standardized APIs. The processor 104 executes compatibility matrix validation algorithms that ensure proper version alignment between different operator versions, hypervisor platforms, and underlying server hardware, preventing configuration conflicts that could result in system instability or performance degradation. The orchestration engine automates the complex process of virtual machine migration and resource reallocation by coordinating operations across multiple virtualization platforms simultaneously, ensuring that the server consolidation plan is executed without service interruption or data loss. The stitching process enables the processor 104 to treat disparate server resources 410 from different manufacturers as a unified resource pool, allowing for seamless workload migration between servers with different hardware architectures, management interfaces, and operational characteristics. The orchestration engine maintains state consistency across all managed components through distributed transaction protocols that ensure atomic execution of complex multi-step consolidation operations, providing rollback capabilities in case of partial failures during the server consolidation implementation process.

The processor 104 accesses the multi-server performance database 402 storing performance data for the determined one or more types of servers. The multi-server performance database 402 contains comprehensive performance metrics, benchmarking data, and operational characteristics for various server configurations and manufacturers. The processor 104 retrieves relevant performance data that corresponds to the identified server types and configurations, enabling informed decision-making for resource allocation and optimization strategies.

The processor 104 utilizes a trained deep learning model 110 to predict infrastructure requirements for the IT workload. In an implementation, the deep learning model 110 is trained on historical resource usage, performance, and cost data to develop predictive capabilities for future resource demands. To utilize the deep learning model 110 for predicting infrastructure requirements, the processor 104 enhances visibility into current telemetry data, data platform metrics, and resource consumption patterns. In another implementation, the deep learning model 110 may be configured to dynamically adjust the predictions based on real-time performance metrics of the allocated server resources, ensuring that predictions remain accurate and relevant as workload conditions change. In some implementations, the deep learning model 110 is trained on historical server resource usage, performance, and cost data. In such implementations, training the deep learning model 110 on the historical server resource usage patterns encompasses CPU utilization, memory consumption, storage input-output operations, and network bandwidth utilization across various IT workloads over time. By analyzing the historical server resource usage patterns, the deep learning model 110 learns to identify trends and correlations between workload characteristics and server resource demands. Further, by training the deep learning model 110 on performance metrics, the deep learning model 110 incorporates data on response times, throughput, and latency for different types of IT applications on various server configurations. The data used for training helps the deep learning model 110 to understand the performance capabilities of different server hardware configurations and virtualization environments. By training the deep learning model 110 on the cost data, historical operational cost information for different server configurations and datacenter services is included to enable cost-effective recommendations. The cost data, historical operational cost information for different server configurations and datacenter services allow the deep learning model 110 to balance performance requirements with operational budget constraints and energy efficiency considerations.

In some other implementations, the deep learning model 110 may be trained on a comprehensive dataset that includes, but is not limited to, server workload characteristics, multi-vendor server specifications, power consumption data, consolidation behaviour, maintenance and failure records, network utilization and data transfer patterns, and temporal utilization variations.

In some examples, the deep learning model 110 is trained on data that describes the nature of various IT workloads, including application types, database operations, web services, and computational complexity requirements. The data describing the nature of different IT workloads helps in predicting server resource requirements for specific types of IT applications and services. In another example, detailed information about the capabilities and limitations of server resources from various manufacturers is incorporated into the training data. The detailed information about the capabilities and limitations of server resources enables the deep learning model 110 to make informed decisions when recommending optimal server configurations across different vendor platforms. In yet another example, historical data on power consumption for different server configurations is included to optimize for energy efficiency, an increasingly important factor in datacenter operations and sustainability initiatives. In yet another example, the deep learning model 110 learns how server resource requirements change as IT workloads scale up or down, enabling accurate predictions for various sizes of enterprise applications and seasonal demand variations. In some other examples, by incorporating data on server hardware failures and maintenance schedules, the deep learning model 110 may factor in reliability and availability when making server consolidation recommendations. In other examples, network utilization and data transfer patterns help the deep learning model 110 optimize for scenarios where data movement between servers or storage systems is a significant performance factor. In some other examples, the deep learning model 110 learns to account for time-based patterns in server resource demand, such as business hours peak usage periods or cyclical batch processing workloads.

In some implementations, by training on a diverse and comprehensive dataset, the deep learning model 110 develops the capability to make nuanced, context-aware predictions for server resource optimization. The deep learning model 110 may identify complex relationships between various factors affecting server infrastructure requirements, enabling it to generate highly optimized recommendations for IT workload placement and server resource consolidation.

In some implementations, the training process of the deep learning model 110 involves techniques such as supervised learning on labelled historical server performance data, as well as potentially incorporating reinforcement learning elements to optimize server allocation decision-making over time. Regular retraining with new datacenter operational data ensures that the deep learning model 110 stays up-to-date with the latest server hardware developments and evolving IT workload patterns.

The data-driven approach to train the deep learning model 110 allows the system 400 to continually improve the predictive accuracy and adapt to changing conditions in the datacenter environment. As a result, organizations can achieve more efficient server resource utilization, reduced operational costs, improved energy efficiency, and enhanced performance for their IT workloads across diverse and complex datacenter infrastructures.

The processor 104 generates recommendations for an optimal server configuration based on the multi-server performance database 402 and the predicted infrastructure requirements that balances performance, power consumption, and resource utilization through sophisticated algorithmic processing. The optimal server configuration may refer to a technical arrangement of server resources that satisfies predicted infrastructure requirements while balancing key operational factors, including system performance, power consumption, and overall resource utilization. The processor 104 executes multi-criteria decision analysis algorithms that evaluate server configuration options against multiple performance vectors simultaneously, incorporating weighted scoring matrices and utility functions to assess the relative importance of different optimization criteria. The recommendation engine retrieves performance benchmarks, power consumption profiles, and resource capacity specifications from the multi-server performance database 402, correlating the historical data with the predicted infrastructure requirements generated by the deep learning model 110 to identify configuration options that meet projected demand while optimizing operational efficiency.

The processor 104 generates recommendations for an optimal server configuration based on the multi-server performance database 402 and the predicted infrastructure requirements using a multi-objective optimization that employ mathematical programming techniques such as genetic algorithms, particle swarm optimization, or evolutionary computation methods. The multi-objective optimization may refer to a process that may be configured to formulate the server configuration problem as a constrained optimization challenge, where multiple conflicting objectives must be simultaneously optimized within defined operational boundaries. The multi-objective optimization evaluates thousands of server configuration combinations, assessing each configuration against performance metrics, including CPU utilization efficiency, memory allocation optimization, storage throughput capabilities, and network bandwidth utilization, while considering power consumption constraints and cost limitations.

In an implementation, the multi-objective optimization utilizes a Pareto front approach to provide multiple optimization solutions that balance CPU readiness time, power consumption, and performance metrics to generate recommendations for an optimal server configuration. The CPU readiness time may refer to a performance metric indicating the amount of time a virtual machine (VM) must wait in a ready-to-run state before being scheduled on a physical CPU core. High CPU readiness time may indicate CPU contention or overcommitment, leading to degraded performance of hosted applications. The Pareto front approach identifies non-dominated solutions where improving one objective would require compromising another objective, creating a frontier of optimal trade-off points that represent mathematically superior configurations. The processor 104 constructs the Pareto front approach by evaluating CPU readiness times, which measure the percentage of time virtual machines wait for CPU resources, against power consumption metrics that quantify energy usage efficiency and performance metrics that assess overall system throughput and response times. The Pareto front approach employs dominance sorting techniques to eliminate sub-optimal solutions and retains only those configurations that represent optimal balances between the competing objectives.

The multi-objective optimization includes user-programmable thresholds comprising a configurable CPU load threshold that does not exceed a predetermined percentage and a configurable power efficiency saving threshold to achieve a target percentage improvement. The processor 104 provides a threshold configuration interface through the customer user interface 118 that enables administrators to define operational constraints and performance targets based on organizational requirements and datacenter policies. The user-programmable thresholds are integrated into the Pareto front approach, ensuring that all generated solutions comply with the predetermined constraints while maintaining optimal trade-offs between competing objectives. The configurable CPU load threshold allows users to specify maximum CPU utilization limits that constrain the Pareto optimization process to generate server configurations that do not exceed the predetermined percentage. For example, when the CPU load threshold is configured to not exceed 70%, the processor 104 filters the output by the Pareto front approach to retain only those server configurations where the predicted CPU utilization remains below 70% across all physical servers in the consolidated deployment. The processor 104 calculates projected CPU utilization for each server configuration using workload analysis data from the input datasets 406 and performance characteristics from the multi-server performance database 402. The configurable power efficiency saving threshold enables users to specify minimum power reduction targets that must be achieved through the server consolidation recommendations generated by the Pareto optimization process. For instance, when the power efficiency saving threshold is configured to achieve a target 10% improvement, the processor 104 evaluates each point on the Pareto front against baseline power consumption measurements to ensure that the recommended server configuration delivers the specified percentage improvement in power efficiency. The processor 104 incorporates power consumption data from the multi-server performance database 402 and calculates projected power savings by comparing consolidated server configurations against current deployment power requirements, eliminating solutions by the Pareto front approach that fail to meet the target percentage improvement while preserving optimal trade-offs among remaining viable configurations. The Pareto front approach enables the identification of multiple viable solutions that represent different trade-offs between competing objectives, allowing for informed decision-making based on specific operational priorities and constraints through interactive visualization and selection mechanisms. The processor 104 presents the output by the Pareto front approach through graphical interfaces that display the relationship between different objectives, enabling administrators to select configurations that align with the organizational priorities, such as minimizing operational costs, maximizing performance, or optimizing energy efficiency. Each point on the Pareto front represents a unique server configuration with associated performance characteristics, power consumption profiles, and resource utilization patterns, providing decision makers with comprehensive information to evaluate the implications of different optimization choices.

The processor 104 automatically allocates server resources based on the recommended optimal server configuration. The allocation process involves provisioning the identified server resources, configuring virtual machines, and establishing network connections to support the IT workload requirements. Before actual implementation, the processor 104 may perform a dry run validation of the server consolidation configuration using virtualization migration simulation to verify the feasibility and effectiveness of the proposed allocation strategy.

The processor 104 generates data for display on a user interface dashboard presenting information about the determined server utilization patterns, the recommended optimal server configuration, and real-time performance metrics of allocated server resources. The dashboard offers comprehensive visibility into system performance, resource utilization trends, and optimization results. In an implementation, the processor 104 may be configured to generate a report comparing the predicted infrastructure requirements with actual performance metrics of the allocated server resources. The generated report provides a continuous improvement of prediction accuracy and optimization effectiveness. Additionally, the processor 104 may generate alerts when the real-time performance metrics deviate from the predicted infrastructure requirements by a predetermined threshold, ensuring proactive management of system performance and resource allocation.

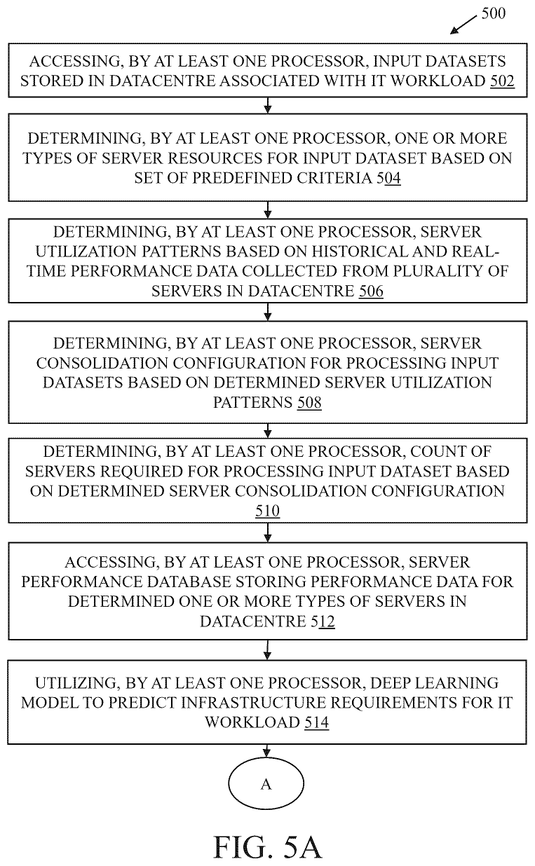

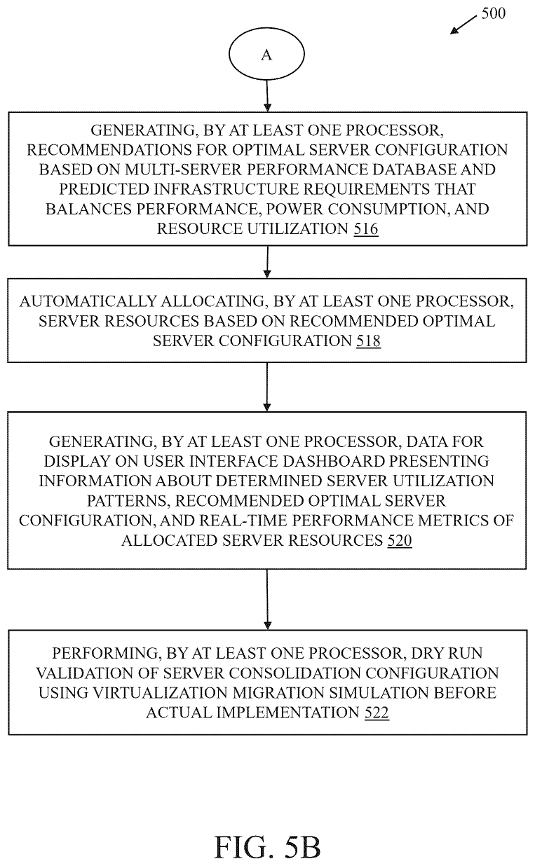

FIG. 5A and FIG. 5B are used in conjunction to explain the method 500. FIGS. 5A and 5B are a flowchart of a method for recommendation, optimization, validation and actual implementation (execution) of information technology (IT) server resources in a datacenter environment, in accordance with an embodiment of the present disclosure. FIGS. 5A and 5B are explained in conjunction with elements from FIGS. 1 to 4. With reference FIGS. 5A and 5B, there is shown a flowchart of a method 500. The method 500 is executed at the server 102 (of FIG. 4). The method 500 may include steps 502 to 522.

At 502, the system 400 accesses input datasets stored in the datacenter 404 associated with the IT workload. The processor 104 establishes secure communication channels with the datacenter 404 through the network interface 108 to retrieve comprehensive datasets that characterize the IT workload requirements and operational parameters. The input datasets may include historical performance logs, configuration files, application metadata, resource consumption records, and real-time telemetry data.

At 504, the system 400 determines one or more types of server resources for the input dataset 406 based on the set of predefined criteria. The processor 104 analyzes the input dataset 406 using algorithmic evaluation techniques to identify server resource types that align with specific operational requirements. The algorithmic evaluation techniques include multi-criteria decision analysis algorithms, such as the Analytic Hierarchy Process (AHP), which assigns weighted scores to different server characteristics, including CPU performance benchmarks, memory capacity requirements, storage throughput capabilities, and power consumption profiles. The processor 104 employs weighted scoring matrices, where each server resource type receives numerical scores across multiple evaluation criteria. Weights are assigned based on organizational priorities, such as cost optimization, performance maximization, or energy efficiency targets. The predefined criteria may include CPU utilization thresholds, power consumption limits, or server performance requirements that define acceptable operational parameters. The processor 104 may employ rule-based decision trees and constraint satisfaction algorithms to evaluate different server configurations against these criteria. The analysis of input dataset 406 ensures resource selection is optimized for specific performance objectives while maintaining operational constraints and cost considerations.

In an implementation, at 506, the system 400 determines server utilization patterns based on historical and real-time performance data collected from the plurality of servers in the datacenter 404. The processor 104 may implement sophisticated pattern recognition algorithms to analyze time-series data representing server performance metrics over extended periods. The utilization patterns are collected using an agentless collector that interfaces with virtualization management systems to gather different performance metrics without requiring additional software deployment on monitored servers. The agentless collector utilizes standardized APIs and management protocols to extract performance data, including CPU usage trends, memory consumption patterns, storage input output characteristics, and network utilization statistics. The non-intrusive monitoring capability of system 400 provides comprehensive visibility into resource utilization without imposing computational overhead on production systems, enabling accurate pattern analysis for optimization purposes.

In another implementation, at 508, the system 400 determines the server consolidation configuration for processing the input datasets based on the determined server utilization patterns. The processor 104 may be configured to apply consolidation algorithms that analyze utilization patterns to identify opportunities for resource optimization through server reduction strategies. The consolidation algorithm evaluates virtual machine placement scenarios, considers resource dependencies, and calculates optimal distribution strategies that maximize server utilization while maintaining performance isolation and ensuring availability requirements. The consolidation algorithm reduces physical server requirements while preserving application performance and operational reliability. The reduction in physical servers results in significant infrastructure cost savings and improved energy efficiency.

At 510, the system 400 determines a count of servers required for processing the input datasets based on the determined server consolidation configuration. The processor 104 may be configured to employ mathematical optimization models to calculate the minimum number of physical servers required to support the consolidated workload configuration. The calculation incorporates parameters such as peak utilization scenarios, resource allocation constraints, and capacity planning requirements to ensure optimal performance under varying load conditions. The server consolidation configuration reduces the total number of physical servers while maintaining performance requirements by redistributing virtual machines across fewer servers, thereby optimizing resource density and operational efficiency. The capacity planning, facilitated by the server consolidation plan, eliminates resource over-provisioning while ensuring sufficient capacity to meet operational demands and growth requirements.

At 512, the system 400 accesses the multi-server performance database 402, which stores performance data for one or more types of servers in the datacenter 404. The processor 104 establishes database connections and executes optimized queries to retrieve relevant performance metrics, benchmarking data, and operational characteristics corresponding to the identified server configurations. The database access mechanism employs indexing strategies and caching techniques to ensure efficient data retrieval and minimize query response times.

At 514, the system 400 utilizes the deep learning model 110 to predict infrastructure requirements for the IT workload. The processor 104 executes the trained deep learning model 110, using the collected utilization patterns and performance data as input features to generate predictive analytics for future resource requirements. In some implementations, the deep learning model 110 may employ neural network architectures optimized for time-series forecasting and resource demand prediction, incorporating techniques such as recurrent neural networks or transformer models to capture temporal dependencies in workload patterns. The proactive infrastructure planning using trained deep learning model 110 enables organizations to anticipate resource needs and optimize capacity allocation before performance degradation occurs to reduce reactive management overhead and improve service reliability.

At 516, the system 400 generates recommendations for the optimal server configuration based on the multi-server performance database 402 and the predicted infrastructure requirements using the multi-objective optimization that balances performance, power consumption, and resource utilization. In an implementation, the processor 104 implements multi-objective optimization that utilize a Pareto front approach to provide multiple optimization solutions that balance CPU readiness times, power consumption, and performance metrics to generate recommendations for an optimal server configuration. The Pareto front approach refers to an optimization technique that identifies non-dominated solutions that represent optimal trade-offs between competing objectives, enabling decision makers to select configurations that best align with the operational priorities.

The multi-objective optimization includes user-programmable thresholds comprising a configurable CPU load threshold that does not exceed a predetermined percentage and a configurable power efficiency saving threshold to achieve a target percentage improvement. The processor 104 provides a configuration interface through the customer user interface 118 that allows administrators to specify operational constraints and performance targets. The user-programmable thresholds helps to achieve operational outcomes while maintaining system performance and reliability standards.

The configurable CPU load threshold allows users to specify maximum CPU utilization limits for server consolidation recommendations, ensuring that consolidated server configurations do not exceed acceptable performance boundaries. For example, an administrator may configure the CPU load threshold to not exceed 70% utilization across all physical servers in the consolidated configuration, preventing resource contention and maintaining adequate headroom for workload spikes and peak demand periods. The processor 104 applies the 70% constraint during the Pareto front optimization process, eliminating server configuration options that would result in CPU utilization levels above the specified threshold of 70% while maximizing consolidation efficiency.

The configurable power efficiency saving threshold enables users to specify minimum power reduction targets that must be achieved through server consolidation recommendations. For example, an organization focused on sustainability initiatives may configure the power efficiency saving threshold to achieve a target 10% reduction in total datacenter power consumption compared to the current non-consolidated server deployment. The processor 104 incorporates power consumption data from the multi-server performance database 402 to calculate projected power savings for each potential server configuration, ensuring that recommended consolidation plans meet or exceed the specified power efficiency targets while maintaining performance requirements.

The processor 104 implements threshold validation algorithms that verify the feasibility of user-specified constraints during the optimization process. If the configured thresholds create conflicting requirements that cannot be simultaneously satisfied, the processor 104 generates alerts through the customer user interface 118 and provides alternative threshold recommendations that enable achievable optimization outcomes. The user-programmable thresholds are stored in the memory 106 and applied consistently across all optimization iterations. The user-programmable thresholds ensures that generated server configuration recommendations comply with organizational policies and operational constraints while maximizing resource utilization efficiency and cost-effectiveness.

At 518, the system 400 automatically allocates server resources based on the recommended optimal server configuration. The processor 104 executes automated provisioning workflows that may configure server resources, establish virtual machine instances, and implement network connectivity according to the optimization recommendations. The allocation process may include resource reservation, configuration deployment, and service initialization procedures.

At 520, the system 400 performs a dry run validation of the server consolidation configuration using virtualization migration simulation before actual implementation. The dry run validation is performed to verify the feasibility and effectiveness of the proposed allocation of the server resources. The dry run simulation creates a virtual environment that models the proposed configuration without affecting production systems, enabling validation of resource allocation decisions and identification of issues before implementation.

At 522, the system 400 generates data for display on the user interface dashboard, presenting information about the determined server utilization patterns, the recommended optimal server configuration, and real-time performance metrics of allocated server resources. The processor 104 implements data visualization algorithms and dashboard rendering techniques to present complex performance data in accessible graphical formats. The dashboard generation process includes real-time data aggregation, metric calculation, and visual representation of key performance indicators. The generated data for display provides enhanced operational visibility that enables administrators to monitor system performance, track optimization results, and make informed decisions based on comprehensive real-time and historical data presentations.

The method 500 provides substantial improvements in datacenter resource management through its comprehensive approach to server optimization and consolidation. The systematic analysis of server utilization patterns enables organizations to identify and eliminate resource inefficiencies that result in significant operational cost savings and reduced energy consumption. The predictive capabilities of the deep learning model 110 allow for proactive capacity planning, preventing both resource shortages and over-provisioning scenarios that commonly plague traditional reactive management approaches. The multi-objective optimization using Pareto front analysis ensures that server configurations achieve an optimal balance between competing performance objectives, thereby avoiding the limitations of single-metric optimization strategies that often lead to suboptimal resource allocation. The agentless data collection mechanism eliminates the overhead and complexity associated with agent-based monitoring solutions while providing comprehensive visibility into system performance across diverse server environments.

Furthermore, the automated allocation and dry run validation capabilities of the method 500 significantly reduce the risk of configuration errors and deployment failures that can result in service disruptions and extended recovery times. The server consolidation planning reduces physical infrastructure requirements while maintaining performance guarantees, enabling organizations to achieve higher resource utilization rates and improved return on infrastructure investments. The real-time dashboard visualization provides operators with immediate visibility into system performance and optimization results, facilitating rapid response to changing conditions and informed decision-making for future capacity planning. The integration of historical data analysis with predictive modelling creates a feedback loop that continuously improves optimization accuracy and effectiveness over time, resulting in increasingly refined resource allocation strategies that adapt to evolving workload characteristics and organizational requirements.

The steps 502 to 522 are only illustrative, and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system for recommendation and optimization of information technology (IT) server resources, the system comprising:
a server comprising at least one processor configured to:
access input datasets stored in a datacenter associated with an IT workload;
determine one or more type of server resources for the input datasets based on a set of predefined criteria;
determine a count of servers required for processing the input datasets based on a determined server consolidation configuration;
access a multi-server performance database storing performance data for the determined one or more types of servers;
utilize a trained deep learning model to predict infrastructure requirements for the IT workload;
generate recommendations for an optimal server configuration based on the multi-server performance database and the predicted infrastructure requirements using a multi-objective optimization that balances performance, power consumption, and resource utilization;
automatically allocate server resources based on the recommended optimal server configuration; and
generate data for display on a user interface dashboard presenting information about the determined server utilization patterns, the recommended optimal server configuration, and real-time performance metrics of allocated server resources.

2. The system of claim 1, wherein the system determines server utilization patterns based on historical and real-time performance data collected from a plurality of servers in the datacenter.

3. The system of claim 1, wherein the system determines a server consolidation configuration for processing the input datasets based on the determined server utilization patterns.

4. The system of claim 1, wherein the set of predefined criteria comprises at least one of: CPU utilization thresholds, power consumption limits, or server performance requirements.

5. The system of claim 1, wherein the server consolidation configuration reduces the total number of physical servers while maintaining performance requirements by redistributing virtual machines across fewer servers.

6. The system of claim 1, wherein the multi-objective optimization utilizes a Pareto front approach to provide multiple optimization solutions that balance CPU readiness times, power consumption, and performance metrics to generate recommendations for an optimal server configuration, wherein the multi-objective optimization includes user-programmable thresholds comprising a configurable CPU load threshold that does not exceed a predetermined percentage and a configurable power efficiency saving threshold to achieve a target percentage improvement.

7. The system of claim 1, wherein the server utilization patterns are collected using an agentless collector that interfaces with virtualization management systems to gather different performance metrics.

8. The system of claim 1, wherein the deep learning model is trained on historical resource usage, performance, and cost data.

9. The system of claim 1, wherein, in order to utilize the deep learning model to predict the infrastructure requirements, the at least one processor is further configured to improve visibility into current telemetry data, data platform metrics, and resource consumption.

10. The system of claim 1, wherein the deep learning model is configured to dynamically adjust its predictions based on real-time performance metrics of the allocated server resources.

11. The system of claim 1, wherein the at least one processor is further configured to generate a report comparing the predicted infrastructure requirements with actual performance metrics of the allocated server resources.

12. A method for recommendation and optimization of information technology (IT) server resources in a datacenter environment, the method comprising:
accessing, by at least one processor, input datasets stored in a datacenter associated with an IT workload;
determining, by the at least one processor, one or more types of server resources for the input datasets based on a set of predefined criteria;
determining, by the at least one processor, a count of servers required for processing the input datasets based on a determined server consolidation configuration;
accessing, by the at least one processor, a multi-server performance database storing performance data for the determined one or more types of servers in the datacenter;
utilizing, by the at least one processor, a deep learning model to predict infrastructure requirements for the IT workload;
generating, by the at least one processor, recommendations for an optimal server configuration based on the multi-server performance database and the predicted infrastructure requirements using a multi-objective optimization that balances performance, power consumption, and resource utilization;
automatically allocating, by the at least one processor, server resources based on the recommended optimal server configuration; and
generating, by the at least one processor, data for display on a user interface dashboard presenting information about the determined server utilization patterns, the recommended optimal server configuration, and real-time performance metrics of allocated server resources.

13. The method of claim 12, wherein the method further comprises determining, by the at least one processor, server utilization patterns based on historical and real-time performance data collected from a plurality of servers in the datacenter.

14. The method of claim 12, wherein the method further comprises determining, by the at least one processor, a server consolidation configuration for processing the input datasets based on the determined server utilization patterns.

15. The method of claim 12, wherein the set of predefined criteria comprises at least one of: CPU utilization thresholds, power consumption limits, or server performance requirements.

16. The method of claim 12, wherein the server consolidation configuration reduces the total number of physical servers while maintaining performance requirements by redistributing virtual machines across fewer servers.

17. The method of claim 12, wherein the multi-objective optimization utilizes a Pareto front approach to provide multiple optimization solutions that balance CPU readiness times, power consumption, and performance metrics to generate recommendations for an optimal server configuration, wherein the multi-objective optimization includes user-programmable thresholds comprising a configurable CPU load threshold that does not exceed a predetermined percentage and a configurable power efficiency saving threshold to achieve a target percentage improvement.

18. The method of claim 12, further comprising performing, by the at least one processor, a dry run validation of the server consolidation configuration using virtualization migration simulation before actual implementation.

19. The method of claim 12, wherein determining server utilization patterns comprises collecting performance data using an agentless collector that interfaces with virtualization management systems to gather different performance metrics.

20. The method of claim 12, wherein utilizing the deep learning model further comprises improving, by the at least one processor, visibility into current telemetry data, data platform metrics, and resource consumption.
